(19) United States
(12) Patent Application Publication
(10) Pub. No.: US 2018/0054253 A1
(43) Pub. Date: Feb. 22, 2018

(54) METHOD AND DEVICE FOR RELAYING BY DEVICE-TO-DEVICE COMMUNICATION TERMINAL IN WIRELESS COMMUNICATION SYSTEM

(71) Applicant: LG ELECTRONICS INC., Seoul (KR)

(72) Inventor: Inkwon SEO, Seoul (KR)

(73) Assignee: LG ELECTRONICS INC., Seoul (KR)

(21) Appl. No.: 15/537,760

(22) PCT Filed: Dec. 28, 2015
(86) PCT No.: PCT/KR2015/014337

§ 371 Date: Jun. 19, 2017

Related U.S. Application Data
(60) Provisional application No. 62/096,887, filed on Dec. 25, 2014.

(51) Int. Cl. H04B 7/26; H04B 17/318

(52) U.S. Cl. CPC H04B 7/2606; H04W 88/04; H04B 17/318

(57) ABSTRACT

The present invention relates to a method for relaying a signal by a device-to-device (D2D) terminal in a wireless communication system, the method comprising the steps of: measuring the signal strength of a signal received from a base station; and, if a terminal successfully decodes the received signal and the strength of the received signal is smaller than a preset threshold value, the terminal relaying a predetermined signal among the signal received from the base station, wherein, if the terminal relays the predetermined signal, mode 1 operation is performed event if a mode configured for the terminal is mode 2.

### TECHNICAL FIELD

Following description relates to a wireless communication system, and more particularly, to a method of performing relay in a D2D communication and an apparatus therefor.

### BACKGROUND ART

Wireless communication systems have been widely deployed to provide various types of communication services such as voice or data. In general, a wireless communication system is a multiple access system that supports communication of multiple users by sharing available system resources (a bandwidth, transmission power, etc.) among them. For example, multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi-Carrier Frequency Division Multiple Access (MC-FDMA) system.

Device-to-Device (D2D) communication means a communication system for directly exchanging audio, data and the like between user equipments without passing through a base station (evolved NodeB: eNB) by establishing a direct link between the user equipments. D2D communication may include such a system as a UE-to-UE (user equipment-to-user equipment) communication, Peer-to-Peer communication and the like. And, the D2D communication system may be applicable to M2M (Machine-to-Machine) communication, MTC (Machine Type Communication) and the like.

D2D communication is currently considered as one of schemes for setting a load put on a base station due to the rapidly increasing data traffic. For instance, according to D2D communication, unlike an existing wireless communication system, since data is exchanged between devices without passing through a base station, overload of a network can be reduced. Moreover, by introducing D2D communication, it is able to expect effects such as procedure reduction of a base station, power consumption reduction of devices involved in D2D, data transmission speed increase, reception capability increase of a network, load distribution, extension of cell coverage and the like.

### DISCLOSURE OF THE INVENTION

### Technical Task

An object of the present invention is to provide a method of selecting a relay and a method of relaying a signal in D2D communication.

Technical tasks obtainable from the present invention are non-limited by the above-mentioned technical task. And, other unmentioned technical tasks can be clearly understood from the following description by those having ordinary skill in the technical field to which the present invention pertains.

### Technical Solution

To achieve these and other advantages and in accordance with the purpose of the present invention, as embodied and broadly described, according to one embodiment, a method of relaying a signal, which is relayed by a D2D (device-to-device) user equipment (UE) in a wireless communication system, includes the steps of measuring signal strength of a signal received from an eNB, and if the UE succeeds in decoding the received signal and strength of the received signal is smaller than a predetermined threshold value, relaying a prescribed signal among the signal received from the eNB. In this case, if the UE relays the prescribed signal, although a mode set to the UE corresponds to a mode 2, the UE performs a mode 1 operation.

To further achieve these and other advantages and in accordance with the purpose of the present invention, according to a different embodiment, a D2D (device-to-device) user equipment (UE) in a wireless communication system includes a transmitter and a receiver, and a processor, the processor configured to measure signal strength of a signal received from an eNB, the processor, if the UE succeeds in decoding the received signal and strength of the received signal is smaller than a predetermined threshold value, configured to relay a prescribed signal among the signal received from the eNB. In this case, if the UE relays the prescribed signal, although a mode set to the UE corresponds to a mode 2, the UE performs a mode 1 operation.

The predetermined threshold value can be configured for UEs located at a cell edge of the eNB to perform the relaying.

The predetermined threshold value may correspond to −120 dBm.

The mode 1 is to directly indicate a resource related to D2D signal transmission by the eNB, the mode 2 is to select a resource related to D2D signal transmission by the UE, and if the UE relays the prescribed signal, a resource used for relaying the prescribed signal can be indicated by the eNB.

The resource used for relaying the prescribed signal can be common to all UEs relaying the prescribed signal.

The prescribed signal may correspond to a downlink signal transmitted in a resource region indicated by the received signal.

A CRC of the received signal can be checked using a relay-RNTI (radio network temporary identifier).

### Advantageous Effects

According to the present invention, it is able to relay a base station signal, a D2D signal, and the like while the number of relay UEs is appropriately maintained.

Effects obtainable from the present invention are non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram for a structure of a radio frame;

FIG. 2 is a diagram for a resource grid in a downlink slot;

FIG. 3 is a diagram for a structure of a downlink subframe;

FIG. 4 is a diagram for a structure of an uplink subframe;

FIG. 5 is a diagram for a configuration of a wireless communication system having multiple antennas;

FIG. 6 is a diagram for a subframe in which a D2D synchronization signal is transmitted;

FIG. 7 is a diagram for explaining relay of a D2D signal;

FIG. 8 is a diagram for an example of a D2D resource pool for performing D2D communication;

FIG. 9 is a diagram for explaining an SA period;

FIG. 10 is a diagram for explaining D2D relay according to one embodiment of the present invention;

FIG. 11 is a diagram for configurations of a transmitter and a receiver.

### BEST MODE

### Mode for Invention

The embodiments of the present invention described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions or features of any one embodiment may be included in another embodiment and may be replaced with corresponding constructions or features of another embodiment.

In the embodiments of the present invention, a description is made, centering on a data transmission and reception relationship between a Base Station (BS) and a User Equipment (UE). The BS is a terminal node of a network, which communicates directly with a UE. In some cases, a specific operation described as performed by the BS may be performed by an upper node of the BS.

Namely, it is apparent that, in a network comprised of a plurality of network nodes including a BS, various operations performed for communication with a UE may be performed by the BS or network nodes other than the BS. The term ‘BS’ may be replaced with the term ‘fixed station’, ‘Node B’, ‘evolved Node B (eNode B or eNB)’, ‘Access Point (AP)’, etc. The term ‘relay’ may be replaced with the term ‘Relay Node (RN)’ or ‘Relay Station (RS)’. The term ‘terminal’ may be replaced with the term ‘UE’, ‘Mobile Station (MS)’, ‘Mobile Subscriber Station (MSS)’, ‘Subscriber Station (SS)’, etc.

The term “cell”, as used herein, may be applied to transmission and reception points such as a base station (eNB), sector, remote radio head (RRH) and relay, and may also be extensively used by a specific transmission/reception point to distinguish between component carriers.

Specific terms used for the embodiments of the present invention are provided to help the understanding of the present invention. These specific terms may be replaced with other terms within the scope and spirit of the present invention.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

The embodiments of the present invention can be supported by standard documents disclosed for at least one of wireless access systems, Institute of Electrical and Electronics Engineers (IEEE) 802, 3rd Generation Partnership Project (3GPP), 3GPP Long Term Evolution (3GPP LTE), LTE-Advanced (LTE-A), and 3GPP2. Steps or parts that are not described to clarify the technical features of the present invention can be supported by those documents. Further, all terms as set forth herein can be explained by the standard documents.

Techniques described herein can be used in various wireless access systems such as Code Division Multiple Access (CDMA), Frequency Division Multiple Access (FDMA), Time Division Multiple Access (TDMA), Orthogonal Frequency Division Multiple Access (OFDMA), Single Carrier-Frequency Division Multiple Access (SC-FDMA), etc. CDMA may be implemented as a radio technology such as Universal Terrestrial Radio Access (UTRA) or CDMA2000. TDMA may be implemented as a radio technology such as Global System for Mobile communications (GSM)/General Packet Radio Service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, Evolved-UTRA (E-UTRA) etc. UTRA is a part of Universal Mobile Telecommunications System (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE. WiMAX can be described by the IEEE 802.16e standard (Wireless Metropolitan Area Network (WirelessMAN)-OFDMA Reference System) and the IEEE 802.16m standard (WirelessMAN-OFDMA Advanced System). For clarity, this application focuses on the 3GPP LTE and LTE-A systems. However, the technical features of the present invention are not limited thereto.

LTE/LTE-A Resource Structure/Channel

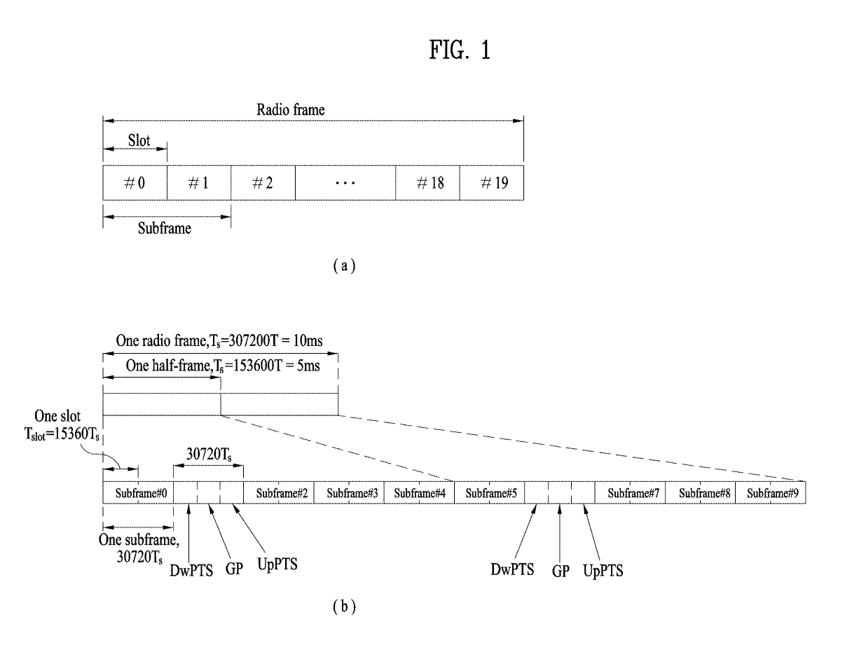

With reference to FIG. 1, the structure of a radio frame will be described below.

In a cellular Orthogonal Frequency Division Multiplexing (OFDM) wireless packet communication system, uplink and/or downlink data packets are transmitted in subframes. One subframe is defined as a predetermined time period including a plurality of OFDM symbols. The 3GPP LTE standard supports a type-1 radio frame structure applicable to Frequency Division Duplex (FDD) and a type-2 radio frame structure applicable to Time Division Duplex (TDD).

FIG. 1(a) illustrates the type-1 radio frame structure. A downlink radio frame is divided into 10 subframes. Each subframe is further divided into two slots in the time domain. A unit time during which one subframe is transmitted is defined as a Transmission Time Interval (TTI). For example, one subframe may be 1 ms in duration and one slot may be 0.5 ms in duration. A slot includes a plurality of OFDM symbols in the time domain and a plurality of Resource Blocks (RBs) in the frequency domain. Because the 3GPP LTE system adopts OFDMA for downlink, an OFDM symbol represents one symbol period. An OFDM symbol may be referred to as an SC-FDMA symbol or symbol period. An RB is a resource allocation unit including a plurality of contiguous subcarriers in a slot.

The number of OFDM symbols in one slot may vary depending on a Cyclic Prefix (CP) configuration. There are two types of CPs: extended CP and normal CP. In the case of the normal CP, one slot includes 7 OFDM symbols. In the case of the extended CP, the length of one OFDM symbol is increased and thus the number of OFDM symbols in a slot is smaller than in the case of the normal CR Thus when the extended CP is used, for example, 6 OFDM symbols may be included in one slot. If channel state gets poor, for example, during fast movement of a UE, the extended CP may be used to further decrease Inter-Symbol Interference (ISI).

In the case of the normal CP, one subframe includes 14 OFDM symbols because one slot includes 7 OFDM symbols. The first two or three OFDM symbols of each subframe may be allocated to a Physical Downlink Control CHannel (PDCCH) and the other OFDM symbols may be allocated to a Physical Downlink. Shared Channel (PDSCH).

FIG. 1(b) illustrates the type-2 radio frame structure. A type-2 radio frame includes two half frames, each having 5 subframes, a Downlink Pilot Time Slot (DwPTS), a Guard Period (GP), and an Uplink Pilot Time Slot (UpPTS). Each subframe is divided into two slots. The DwPTS is used for initial cell search, synchronization, or channel estimation at a UE. The UpPTS is used for channel estimation and acquisition of uplink transmission synchronization to a UE at an eNB. The GP is a period between an uplink and a downlink, which eliminates uplink interference caused by multipath delay of a downlink signal. One subframe includes two slots irrespective of the type of a radio frame.

The above-described radio frame structures are purely exemplary and thus it is to be noted that the number of subframes in a radio frame, the number of slots in a subframe, or the number of symbols in a slot may vary.

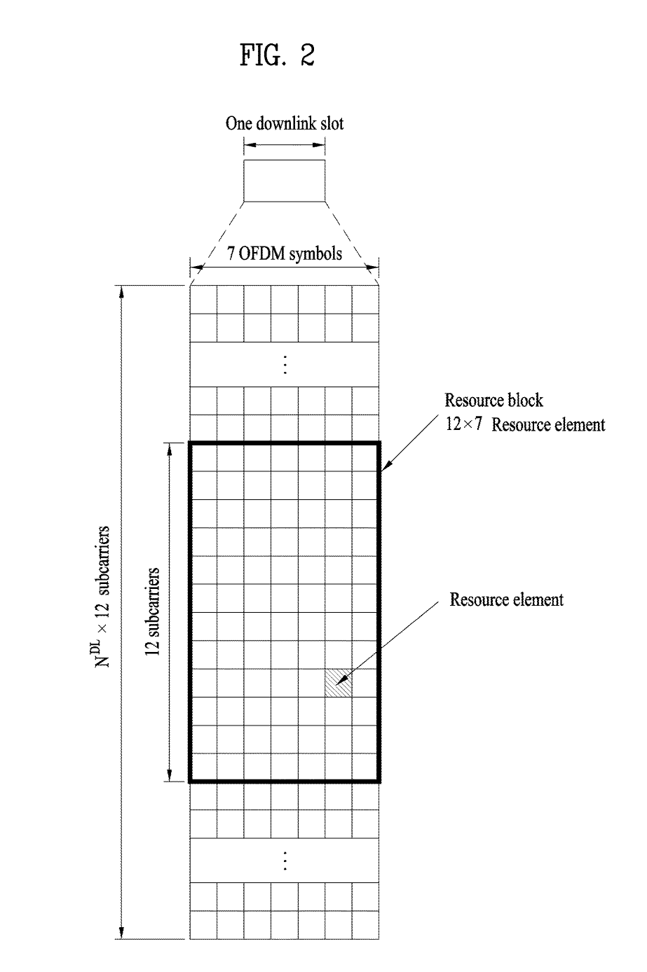

FIG. 2 illustrates the structure of a downlink resource grid for the duration of one downlink slot. A downlink slot includes 7 OFDM symbols in the time domain and an RB includes 12 subcarriers in the frequency domain, which does not limit the scope and spirit of the present invention. For example, a downlink slot may include 7 OFDM symbols in the case of the normal CP, whereas a downlink slot may include 6 OFDM symbols in the case of the extended CP. Each element of the resource grid is referred to as a Resource Element (RE). An RB includes 12×7 REs. The number of RBs in a downlink slot, NDL depends on a downlink transmission bandwidth. An uplink slot may have the same structure as a downlink slot.

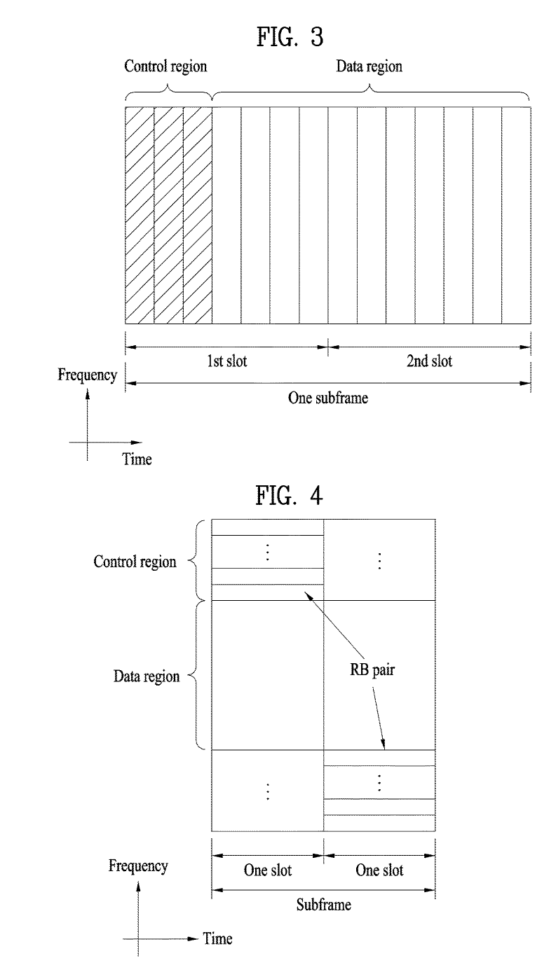

FIG. 3 illustrates the structure of a downlink subframe. Up to three OFDM symbols at the start of the first slot in a downlink subframe are used for a control region to which control channels are allocated and the other OFDM symbols of the downlink subframe are used for a data region to which a PDSCH is allocated. Downlink control channels used in the 3GPP LTE system include a Physical Control Format Indicator CHannel (PCFICH), a Physical Downlink Control CHannel (PDCCH), and a Physical Hybrid automatic repeat request (HARQ) Indicator CHannel (PHICH). The PCFICH is located in the first OFDM symbol of a subframe, carrying information about the number of OFDM symbols used for transmission of control channels in the subframe. The PHICH delivers an HARQ ACKnowledgment/Negative ACKnowledgment (ACK/NACK) signal in response to an uplink transmission. Control information carried on the PDCCH is called Downlink Control Information (DCI). The DCI transports uplink or downlink scheduling information, or uplink transmission power control commands for UE groups. The PDCCH delivers information about resource allocation and a transport format for a Downlink Shared CHannel (DL-SCH), resource allocation information about an Uplink Shared CHannel (UL-SCH), paging information of a Paging CHannel (PCH), system information on the DL-SCH, information about resource allocation for a higher-layer control message such as a Random Access Response transmitted on the PDSCH, a set of transmission power control commands for individual UEs of a UE group, transmission power control information, Voice Over Internet Protocol (VoIP) activation information, etc. A plurality of PDCCHs may be transmitted in the control region. A UE may monitor a plurality of PDCCHs. A PDCCH is formed by aggregating one or more consecutive Control Channel Elements (CCEs). A CCE is a logical allocation unit used to provide a PDCCH at a coding rate based on the state of a radio channel. A CCE includes a plurality of RE groups. The format of a PDCCH and the number of available bits for the PDCCH are determined according to the correlation between the number of CCEs and a coding rate provided by the CCEs. An eNB determines the PDCCH format according to DCI transmitted to a UE and adds a Cyclic Redundancy Check (CRC) to control information. The CRC is masked by an Identifier (ID) known as a Radio Network Temporary Identifier (RNTI) according to the owner or usage of the PDCCH. If the PDCCH is directed to a specific UE, its CRC may be masked by a cell-RNTI (C-RNTI) of the UE. If the PDCCH is for a paging message, the CRC of the PDCCH may be masked by a Paging Indicator Identifier (P-RNTI). If the PDCCH carries system information, particularly, a System Information Block (SIB), its CRC may be masked by a system information ID and a System Information RNTI (SI-RNTI). To indicate that the PDCCH carries a Random Access Response in response to a Random Access Preamble transmitted by a UE, its CRC may be masked by a Random Access-RNTI (RA-RNTI).

FIG. 4 illustrates the structure of an uplink subframe. An uplink subframe may be divided into a control region and a data region in the frequency domain. A Physical Uplink Control CHannel (PUCCH) carrying uplink control information is allocated to the control region and a Physical Uplink Shared Channel (PUSCH) carrying user data is allocated to the data region. To maintain the property of a single carrier, a UE does not transmit a PUSCH and a PUCCH simultaneously. A PUCCH for a UE is allocated to an RB pair in a subframe. The RBs of the RB pair occupy different subcarriers in two slots. Thus it is said that the RB pair allocated to the PUCCH is frequency-hopped over a slot boundary.

Reference Signals (RSs)

In a wireless communication system, a packet is transmitted on a radio channel. In view of the nature of the radio channel, the packet may be distorted during the transmission. To receive the signal successfully, a receiver should compensate for the distortion of the received signal using channel information. Generally, to enable the receiver to acquire the channel information, a transmitter transmits a signal known to both the transmitter and the receiver and the receiver acquires knowledge of channel information based on the distortion of the signal received on the radio channel. This signal is called a pilot signal or an RS.

In the case of data transmission and reception through multiple antennas, knowledge of channel states between Transmission (Tx) antennas and Reception (Rx) antennas is required for successful signal reception. Accordingly, an RS should be transmitted through each Tx antenna.

RSs may be divided into downlink RSs and uplink RSs. In the current LTE system, the uplink RSs include:

i) DeModulation-Reference Signal (DM-RS) used for channel estimation for coherent demodulation of information delivered on a PUSCH and a PUCCH; and

ii) Sounding Reference Signal (SRS) used for an eNB or a network to measure the quality of an uplink channel in a different frequency.

The downlink RSs are categorized into:

i) Cell-specific Reference Signal (CRS) shared among all UEs of a cell;

ii) UE-specific RS dedicated to a specific UE;

iii) DM-RS used for coherent demodulation of a PDSCH, when the PDSCH is transmitted;

iv) Channel State Information-Reference Signal (CSI-RS) carrying CSI, when downlink DM-RSs are transmitted;

v) Multimedia Broadcast Single Frequency Network (MBSFN) RS used for coherent demodulation of a signal transmitted in MBSFN mode; and

vi) positioning RS used to estimate geographical position information about a UE.

RSs may also be divided into two types according to their purposes: RS for channel information acquisition and RS for data demodulation. Since its purpose lies in that a UE acquires downlink channel information, the former should be transmitted in a broad band and received even by a UE that does not receive downlink data in a specific subframe. This RS is also used in a situation like handover. The latter is an RS that an eNB transmits along with downlink data in specific resources. A UE can demodulate the data by measuring a channel using the RS. This RS should be transmitted in a data transmission area.

Modeling of MIMO System

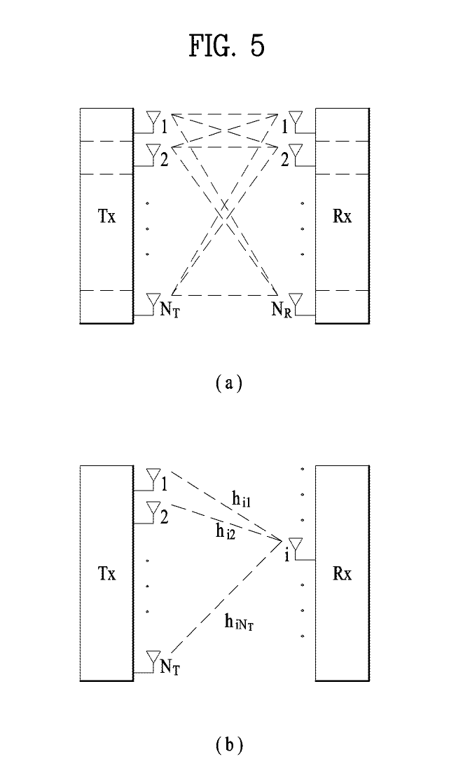

FIG. 5 is a diagram illustrating a configuration of a wireless communication system having multiple antennas.

As shown in FIG. 5(a), if the number of transmit antennas is increased to NT and the number of receive antennas is increased to NR, a theoretical channel transmission capacity is increased in proportion to the number of antennas, unlike the case where a plurality of antennas is used in only a transmitter or a receiver. Accordingly, it is possible to improve a transfer rate and to remarkably improve frequency efficiency. As the channel transmission capacity is increased, the transfer rate may be theoretically increased by a product of a maximum transfer rate Ro upon utilization of a single antenna and a rate increase ratio Ri.

Rᵢ=min(N_{T},N_{R}) [Equation 1]

For instance, in an MIMO communication system, which uses 4 transmit antennas and 4 receive antennas, a transmission rate 4 times higher than that of a single antenna system can be obtained. Since this theoretical capacity increase of the MIMO system has been proved in the middle of 90's, many ongoing efforts are made to various techniques to substantially improve a data transmission rate. In addition, these techniques are already adopted in part as standards for various wireless communications such as 3G mobile communication, next generation wireless LAN and the like.

The trends for the MIMO relevant studies are explained as follows. First of all, many ongoing efforts are made in various aspects to develop and research information theory study relevant to MIMO communication capacity calculations and the like in various channel configurations and multiple access environments, radio channel measurement and model derivation study for MIMO systems, spatiotemporal signal processing technique study for transmission reliability enhancement and transmission rate improvement and the like.

In order to explain a communicating method in an MIMO system in detail, mathematical modeling can be represented as follows. It is assumed that there are NT transmit antennas and NR receive antennas.

Regarding a transmitted signal, if there are NT transmit antennas, the maximum number of pieces of information that can be transmitted is NT. Hence, the transmission information can be represented as shown in Equation 2.

S=└s₁,s₂, . . . ,s_{N}_{_{T}}┘^{T} [Equation 2]

Meanwhile, transmit powers can be set different from each other for individual pieces of transmission information s₁, s₂, . . . , s_{N}_{_{T}}, respectively. If the transmit powers are set to P₁, P₂, . . . , P_{N}_{_{T}} respectively, the transmission information with adjusted transmit powers can be represented as Equation 3.

ŝ=[ŝ₁,ŝ₂, . . . ,ŝ_{N}_{_{T}}]^{T}=[P₁s₁,P₂s₂, . . . ,P_{N}_{_{T}}s_{N}_{_{T}}]^{T} [Equation 3]

In addition, Ŝ can be represented as Equation 4 using diagonal matrix P of the transmission power.

$$\hat{s} = [ \begin{matrix}{P}_{1} & & & 0 \\ & {P}_{2} & & \\ & & ⋱ & \\ 0 & & & {P}_{{N}_{T}}\end{matrix} ] [ \begin{matrix}{s}_{1} \\ {s}_{2} \\ ⋮ \\ {s}_{{N}_{T}}\end{matrix} ] = Ps \qquad [ Equation 4 ]$$

Assuming a case of configuring NT transmitted signals x₁, x₂, . . . , x_{N}_{_{T}}, which are actually transmitted, by applying weight matrix W to the information vector Ŝ having the adjusted transmit powers, the weight matrix W serves to appropriately distribute the transmission information to each antenna according to a transport channel state. x₁, x₂, . . . , x_{N}_{_{T}} can be expressed by using the vector X as follows.

$$x = [ \begin{matrix}{x}_{1} \\ {x}_{2} \\ ⋮ \\ {x}_{i} \\ ⋮ \\ {x}_{{N}_{T}}\end{matrix} ] = [ \begin{matrix}{w}_{11} & {w}_{12} & … & {w}_{1 {N}_{T}} \\ {w}_{21} & {w}_{22} & … & {w}_{2 {N}_{T}} \\ ⋮ & & ⋱ & \\ {w}_{i 1} & {w}_{i 2} & … & {w}_{{iN}_{T}} \\ ⋮ & & ⋱ & \\ {w}_{{N}_{T} 1} & {w}_{{N}_{T} 2} & … & {w}_{{N}_{T} {N}_{T}}\end{matrix} ] [ \begin{matrix}{\hat{s}}_{1} \\ {\hat{s}}_{2} \\ ⋮ \\ {\hat{s}}_{j} \\ ⋮ \\ {\hat{s}}_{{N}_{T}}\end{matrix} ] = W \hat{s} = WPs \qquad [ Equation 5 ]$$

In Equation 5, wᵢⱼ denotes a weight between an i^{th} transmit antenna and j^{th} information. W is also called a precoding matrix.

If the NR receive antennas are present, respective received signals y₁, y₂, . . . , y_{N}_{_{T}} of the antennas can be expressed as follows.

y=[y₁,y₂, . . . ,y_{N}_{_{T}}]^{T} [Equation 6]

If channels are modeled in the MIMO wireless communication system, the channels may be distinguished according to transmit/receive antenna indexes. A channel from the transmit antenna j to the receive antenna i is denoted by hᵢⱼ. In hᵢⱼ, it is noted that the indexes of the receive antennas precede the indexes of the transmit antennas in view of the order of indexes.

FIG. 5(b) is a diagram illustrating channels from the NT transmit antennas to the receive antenna i. The channels may be combined and expressed in the form of a vector and a matrix. In FIG. 5(b), the channels from the NT transmit antennas to the receive antenna i can be expressed as follows.

hᵢ^{T}=[hᵢ₁,hᵢ₂, . . . ,h_{iN}_{_{T}}] [Equation 7]

Accordingly, all channels from the NT transmit antennas to the NR receive antennas can be expressed as follows.

$$H = [ \begin{matrix}{h}_{1}^{T} \\ {h}_{2}^{T} \\ ⋮ \\ {h}_{i}^{T} \\ ⋮ \\ {h}_{{N}_{R}}^{T}\end{matrix} ] = [ \begin{matrix}{h}_{11} & {h}_{12} & … & {h}_{1 {N}_{T}} \\ {h}_{21} & {h}_{22} & … & {h}_{2 {N}_{T}} \\ ⋮ & & ⋱ & \\ {h}_{i 1} & {h}_{i 2} & … & {h}_{{iN}_{T}} \\ ⋮ & & ⋱ & \\ {h}_{{N}_{R} 1} & {h}_{{N}_{R} 2} & … & {h}_{{N}_{R} {N}_{T}}\end{matrix} ] \qquad [ Equation 8 ]$$

An AWGN (Additive White Gaussian Noise) is added to the actual channels after a channel matrix H. The AWGN n₁, n₂, . . . , n_{N}_{_{R}} respectively added to the NR receive antennas can be expressed as follows.

n=[n₁,n₂, . . . ,n_{N}_{_{R}}]^{T} [Equation 9]

Through the above-described mathematical modeling, the received signals can be expressed as follows.

$$y = [ \begin{matrix}{y}_{1} \\ {y}_{2} \\ ⋮ \\ {y}_{i} \\ ⋮ \\ {y}_{{N}_{R}}\end{matrix} ] = [ \begin{matrix}{h}_{11} & {h}_{12} & … & {h}_{1 {N}_{T}} \\ {h}_{21} & {h}_{22} & … & {h}_{2 {N}_{T}} \\ ⋮ & & ⋱ & \\ {h}_{i 1} & {h}_{i 2} & … & {h}_{{iN}_{T}} \\ ⋮ & & ⋱ & \\ {h}_{{N}_{R} 1} & {h}_{{N}_{R} 2} & … & {h}_{{N}_{R} {N}_{T}}\end{matrix} ] [ \begin{matrix}{x}_{1} \\ {x}_{2} \\ ⋮ \\ {x}_{j} \\ ⋮ \\ {x}_{{N}_{T}}\end{matrix} ] + [ \begin{matrix}{n}_{1} \\ {n}_{2} \\ ⋮ \\ {n}_{i} \\ ⋮ \\ {n}_{{N}_{R}}\end{matrix} ] = Hx = n \qquad [ Equation 10 ]$$

Meanwhile, the number of rows and columns of the channel matrix H indicating the channel state is determined by the number of transmit and receive antennas. The number of rows of the channel matrix H is equal to the number NR of receive antennas and the number of columns thereof is equal to the number NR of transmit antennas. That is, the channel matrix H is an NR×NT matrix.

The rank of the matrix is defined by the smaller of the number of rows and the number of columns, which are independent from each other. Accordingly, the rank of the matrix is not greater than the number of rows or columns. The rank rank(H) of the channel matrix His restricted as follows.

rank(H)≦min(N_{T},N_{R}) [Equation 11]

Additionally, the rank of a matrix can also be defined as the number of non-zero Eigen values when the matrix is Eigen-value-decomposed. Similarly, the rank of a matrix can be defined as the number of non-zero singular values when the matrix is singular-value-decomposed. Accordingly, the physical meaning of the rank of a channel matrix can be the maximum number of channels through which different pieces of information can be transmitted.

In the description of the present document, ‘rank’ for MIMO transmission indicates the number of paths capable of sending signals independently on specific time and frequency resources and ‘number of layers’ indicates the number of signal streams transmitted through the respective paths. Generally, since a transmitting end transmits the number of layers corresponding to the rank number, one rank has the same meaning of the layer number unless mentioned specially.

Synchronization Acquisition of D2D UE

Now, a description will be given of synchronization acquisition between UEs in D2D communication based on the foregoing description in the context of the legacy LTE/LTE-A system. In an OFDM system, if time/frequency synchronization is not acquired, the resulting Inter-Cell Interference (ICI) may make it impossible to multiplex different UEs in an OFDM signal. If each individual D2D UE acquires synchronization by transmitting and receiving a synchronization signal directly, this is inefficient. In a distributed node system such as a D2D communication system, therefore, a specific node may transmit a representative synchronization signal and the other UEs may acquire synchronization using the representative synchronization signal. In other words, some nodes (which may be an eNB, a UE, and a Synchronization Reference Node (SRN, also referred to as a synchronization source)) may transmit a D2D Synchronization Signal (D2DSS) and the remaining UEs may transmit and receive signals in synchronization with the D2DSS.

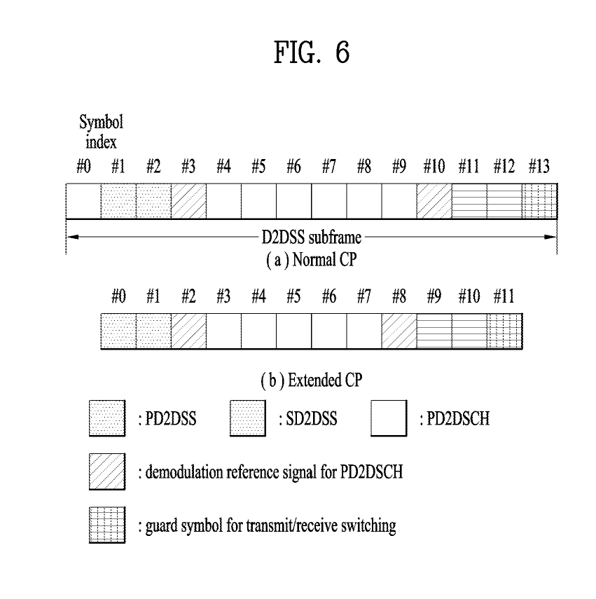

D2DSSs may include a Primary D2DSS (PD2DSS) or a Primary Sidelink Synchronization Signal (PSSS) and a Secondary D2DSS (SD2DSS) or a Secondary Sidelink Synchronization Signal (SSSS). The PD2DSS may be configured to have a similar/modified/repeated structure of a Zadoff-chu sequence of a predetermined length or a Primary Synchronization Signal (PSS). Unlike a DL PSS, the PD2DSS may use a different Zadoff-chu root index (e.g., 26, 37). And, the SD2DSS may be configured to have a similar/modified/repeated structure of an M-sequence or a Secondary Synchronization Signal (SSS). If UEs synchronize their timing with an eNB, the eNB serves as an SRN and the D2DSS is a PSS/SSS. Unlike PSS/SSS of DL, the PD2DSS/SD2DSS follows UL subcarrier mapping scheme. FIG. 6 shows a subframe in which a D2D synchronization signal is transmitted. A Physical D2D Synchronization Channel (PD2DSCH) may be a (broadcast) channel carrying basic (system) information that a UE should first obtain before D2D signal transmission and reception (e.g., D2DSS-related information, a Duplex Mode (DM), a TDD UL/DL configuration, a resource pool-related information, the type of an application related to the D2DSS, etc.). The PD2DSCH may be transmitted in the same subframe as the D2DSS or in a subframe subsequent to the frame carrying the D2DSS. A DMRS can be used to demodulate the PD2DSCH.

The SRN may be a node that transmits a D2DSS and a PD2DSCH. The D2DSS may be a specific sequence and the PD2DSCH may be a sequence representing specific information or a codeword produced by predetermined channel coding. The SRN may be an eNB or a specific D2D UE. In the case of partial network coverage or out of network coverage, the SRN may be a UE.

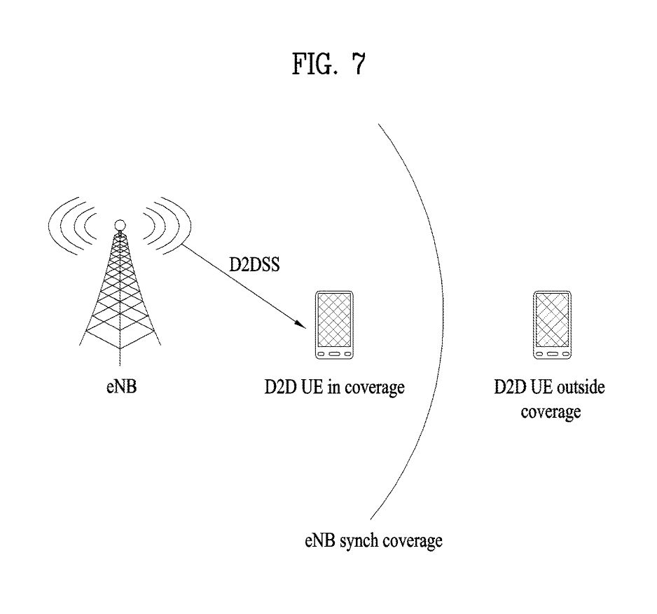

In a situation illustrated in FIG. 7, a D2DSS may be relayed for D2D communication with an out-of-coverage UE. The D2DSS may be relayed over multiple hops. The following description is given with the appreciation that relay of an SS covers transmission of a D2DSS in a separate format according to a SS reception time as well as direct Amplify-and-Forward (AF)-relay of an SS transmitted by an eNB. As the D2DSS is relayed, an in-coverage UE may communicate directly with an out-of-coverage UE.

D2D Resource Pool

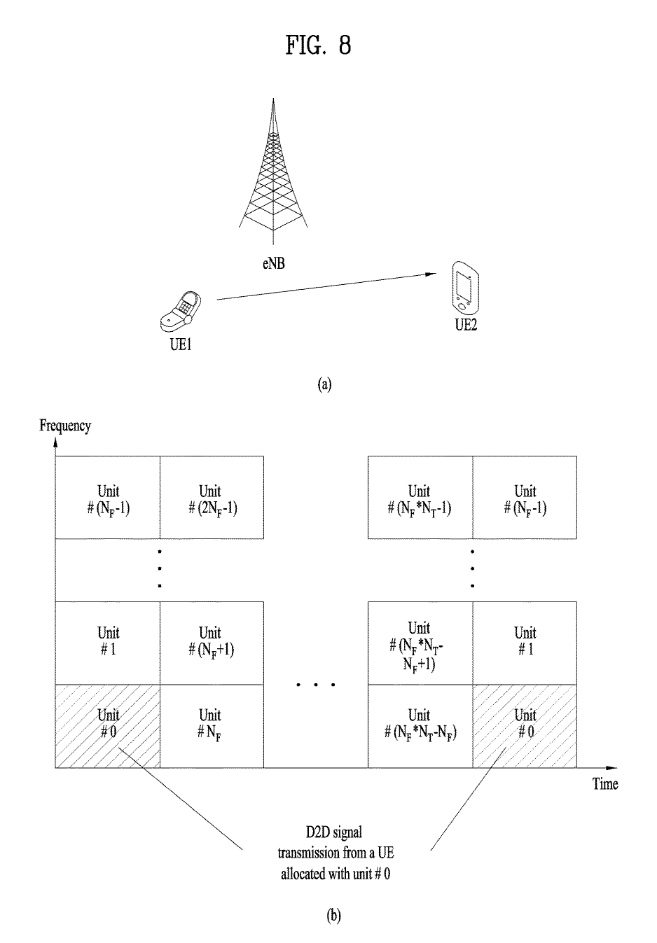

FIG. 8 shows an example of a UE1, a UE2 and a resource pool used by the UE1 and the UE2 performing D2D communication. In FIG. 8 (a), a UE corresponds to a terminal or such a network device as an eNB transmitting and receiving a signal according to a D2D communication scheme. A UE selects a resource unit corresponding to a specific resource from a resource pool corresponding to a set of resources and the UE transmits a D2D signal using the selected resource unit. A UE2 corresponding to a reception UE receives a configuration of a resource pool in which the UE1 is able to transmit a signal and detects a signal of the UE1 in the resource pool. In this case, if the UE1 is located at the inside of coverage of an eNB, the eNB can inform the UE1 of the resource pool. If the UE1 is located at the outside of coverage of the eNB, the resource pool can be informed by a different UE or can be determined by a predetermined resource. In general, a resource pool includes a plurality of resource units. A UE selects one or more resource units from among a plurality of the resource units and may be able to use the selected resource unit(s) for D2D signal transmission. FIG. 8 (b) shows an example of configuring a resource unit. Referring to FIG. 8 (b), the entire frequency resources are divided into the N_{F} number of resource units and the entire time resources are divided into the N_{T} number of resource units. In particular, it is able to define N_{F}*N_{T} number of resource units in total. In particular, a resource pool can be repeated with a period of N_{T} subframes. Specifically, as shown in FIG. 8, one resource unit may periodically and repeatedly appear. Or, an index of a physical resource unit to which a logical resource unit is mapped may change with a predetermined pattern according to time to obtain a diversity gain in time domain and/or frequency domain. In this resource unit structure, a resource pool may correspond to a set of resource units capable of being used by a UE intending to transmit a D2D signal.

A resource pool can be classified into various types. First of all, the resource pool can be classified according to contents of a D2D signal transmitted via each resource pool. For example, the contents of the D2D signal can be classified into various signals and a separate resource pool can be configured according to each of the contents. The contents of the D2D signal may include SA (scheduling assignment), a D2D data channel, and a discovery channel. The SA may correspond to a signal including information on a resource position of a D2D data channel, information on MCS (modulation and coding scheme) necessary for modulating and demodulating a data channel, information on a MIMO transmission scheme, information on TA (timing advance), and the like. The SA signal can be transmitted on an identical resource unit in a manner of being multiplexed with D2D data. In this case, an SA resource pool may correspond to a pool of resources that an SA and D2D data are transmitted in a manner of being multiplexed. The SA signal can also be referred to as a D2D control channel or a PSCCH (physical sidelink control channel). The D2D data channel (or, PSSCH (physical sidelink shared channel)) corresponds to a resource pool used by a transmission UE to transmit user data. If an SA and a D2D data are transmitted in a manner of being multiplexed in an identical resource unit, D2D data channel except SA information can be transmitted only in a resource pool for the D2D data channel. In other word, resource elements (REs), which are used to transmit SA information in a specific resource unit of an SA resource pool, can also be used for transmitting D2D data in a D2D data channel resource pool. The discovery channel may correspond to a resource pool for a message that enables a neighboring UE to discover transmission UE transmitting information such as ID of the UE, and the like.

Although contents of D2D signal are identical to each other, it may use a different resource pool according to a transmission/reception attribute of the D2D signal. For example, in case of the same D2D data channel or the same discovery message, the D2D data channel or the discovery signal can be classified into a different resource pool according to a transmission timing determination scheme (e.g., whether a D2D signal is transmitted at the time of receiving a synchronization reference signal or the timing to which a prescribed timing advance is added) of a D2D signal, a resource allocation scheme (e.g., whether a transmission resource of an individual signal is designated by an eNB or an individual transmission UE selects an individual signal transmission resource from a pool), a signal format (e.g., number of symbols occupied by a D2D signal in a subframe, number of subframes used for transmitting a D2D signal), signal strength from an eNB, strength of transmit power of a D2D UE, and the like. For clarity, a method for an eNB to directly designate a transmission resource of a D2D transmission UE is referred to as a mode 1. If a transmission resource region is configured in advance or an eNB designates the transmission resource region and a UE directly selects a transmission resource from the transmission resource region, it is referred to as a mode 2. In case of performing D2D discovery, if an eNB directly indicates a resource, it is referred to as a type 2. If a UE directly selects a transmission resource from a predetermined resource region or a resource region indicated by the eNB, it is referred to as a type 1.

Transmission and Reception of SA

A mode 1 UE can transmit an SA signal (or, a D2D control signal, SCI (sidelink control information)) via a resource configured by an eNB. A mode 2 UE receives a configured resource to be used for D2D transmission. The mode 2 UE can transmit SA by selecting a time frequency resource from the configured resource.

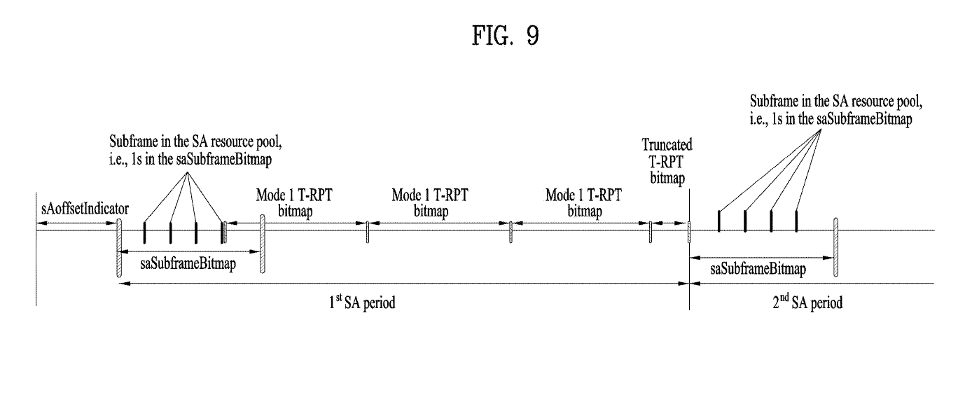

The SA period can be defined as FIG. 9. Referring to FIG. 9, a first SA period can start at a subframe apart from a specific system frame as much as a prescribed offset (SAOffsetIndicator) indicated by higher layer signaling. Each SA period can include an SA resource pool and a subframe pool for transmitting D2D data. The SA resource pool can include subframes ranging from a first subframe of an SA period to the last subframe among subframes indicated by a subframe bitmap (saSubframeBitmap) to transmit SA. In case of mode 1, T-RPT (time-resource pattern for transmission) is applied to the resource pool for transmitting D2D data to determine a subframe in which an actual data is transmitted. As shown in the drawing, if the number of subframes included in an SA period except the SA resource pool is greater than the number of T-RPT bits, the T-RPT can be repeatedly applied and the lastly applied T-RPT can be applied in a manner of being truncated as many as the number of remaining subframes.

Signal Relaying Method of D2D UE

In the following, a method for a D2D UE to relay a signal is explained. The signal relayed by the D2D UE may correspond to the D2D signal mentioned earlier in FIG. 7 or a signal transmitted by an eNB. For example, in order for an eNB to forward data to an out-coverage UE or a UE located at a coverage hole where a link status with the eNB is unstable, the eNB can use a UE relay. In this case, the signal can be relayed. In the following, a base station may correspond to an eNB or a UE performing an operation corresponding to the eNB. For example, when a plurality of UEs configure a cluster in out-of-coverage, a cluster header UE performing scheduling in the cluster may also belong to the scope of the eNB.

According to one embodiment of the present invention, when a UE measures signal strength of a signal received from an eNB and succeeds in decoding the received signal, if the signal strength is smaller than a predetermined threshold, the UE can relay a prescribed signal among the signal received from the eNB. This can be comprehended as a reference for selecting a UE to perform a relay operation is provided. In particular, the eNB can select a UE capable of operating as a relay from among UEs having a good link status with the eNB using the reference. In the foregoing description, the predetermined threshold can be configured to make UEs located at the cell edge of the eNB perform relaying. For example, the predetermined threshold may correspond to −120 dBm. This is configured in consideration of general RSRP (i.e., −120 dBM) of a UE located at the cell edge. It may also use a different specific value (e.g., −110, 100 dBm). According to 3GPP 36.133, as shown in Table 1 in the following, a range of an RSRP reporting value corresponds to a range ranging from −140 dBm to −44 dBm. In particular, the predetermined threshold value can be determined by a value capable of being appropriately selected by the UE located at the cell edge.

TABLE 1

| Reported | Measured | |
|---|---|---|
| value | quantity value | Unit |
| RSRP_00 | RSRP < −140 | dBm |
| RSRP_01 | −140 ≦ RSRP < −139 | dBm |
| RSRP_02 | −139 ≦ RSRP < −138 | dBm |
| . . . | . . . | . . . |
| RSRP_95 | −46 ≦ RSRP < −45 | dBm |
| RSRP_96 | −45 ≦ RSRP < −44 | dBm |
| RSRP_97 | −44 ≦ RSRP | dBm |

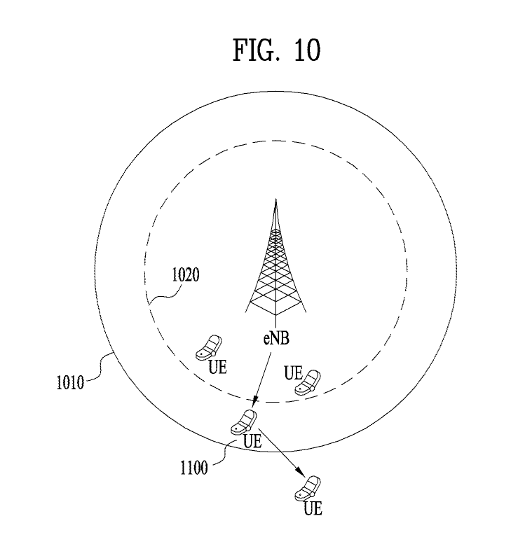

In particular, the aforementioned configuration corresponds to a method for appropriately controlling/maintaining the number of relay UEs. In general, it may be able to represent as relaying is performed when RSRP<X or Y<RSRP<X. In this case, the X and the Y can be forwarded via higher layer signaling. Or, if decoding on a signal (D2D grant and/or data indicated by the D2D grant), which is received together with the abovementioned condition, is successful, it may perform relaying. In relation to this, referring to FIG. 10, X may correspond to an outside region of a circle indicated by 1020 and Y or successful decoding may correspond to an inside region of the circle indicated by 1010. In this case, a signal of an eNB can be relayed by a UE 1100 only based on the aforementioned configuration.

If the UE relays the prescribed signal, although a mode set to the UE corresponds to the mode 2, the UE can perform an operation of the mode 1. More specifically, although a mode, which is configured (immediately) before the UE performs a relay operation, corresponds to the mode 1, the relay operation can be performed in a resource indicated by the eNB. In particular, when the UE relays the prescribed signal, a resource used for relaying the prescribed signal can be indicated by the eNB. Moreover, the resource used for relaying the prescribed signal is common to all UEs relaying the prescribed signal. By doing so, it may be able to minimize signal interference due to the relay operation.

Subsequently, in the foregoing description, the signal, which is received by the UE from the eNB to measure signal strength, may correspond to a D2D grant. In order to check a CRC of the D2D grant (the received signal), it may use a relay-RNTI (radio network temporary identifier). Unlike DCI defined in legacy LTE/LTE-A system, the D2D grant can be newly defined or can be defined by setting a specific reserved field of the predefined DCI to 1 (This indicates that data transmitted from a resource allocated by the grant should be relayed). This can be comprehended as a method of broadcasting data together with such a signaling as “relay is required” as a different method of forwarding relay-required data to a relay. The D2D grant can indicate resource allocation information on a region to which data (to be forwarded to an out-of-coverage UE by an eNB) to be relayed for a relay operation instead of configuring a resource (e.g., time/frequency resource allocation, hopping flag, TPC, etc.) for D2D. In this case, the resource allocation information indicated by the D2D grant may use a DL allocation method of a legacy LTE/LTE-A system. In the foregoing description, the prescribed signal may correspond to a DL signal transmitted in a resource region indicated by the received signal (i.e., D2D grant). DCI based on a legacy UL grant can be used for a D2D operation requested by a UE and DCI based on DL allocation can be used for a D2D relay operation for forwarding data to an out-of-coverage UE. DCI for (eNB to out-UE) D2D relay can indicate a resource for a D2D operation of a D2D transmitter defined by the current D2D grant and a PDSCH resource in which data to be relayed is transmitted. As a different method of indicating a PDSCH region in which data is transmitted, it may be able to configure a part of data transmitted to a relay UE by an eNB to be relayed (i.e., a relay UE receives both DL data for the relay UE and data to be related). To this end, it may be able to indicate a codeword index, a TB index, etc. of the data to be relayed to relay corresponding information. In this case, since the information is forwarded using a scheme defined in the legacy LTE/LTE-A system and the D2D grant for relaying forwards an index of the data to be relayed only, it is able to reduce a DCI size.

Meanwhile, as a method of selecting/designating a UE to be operated as a relay, when a UE reports a UE category to the eNB, the UE can also forward information on whether or not the UE is able to operate as a relay to the eNB. This can be comprehended as whether or not a UE is able to operate as a relay can be considered as one of elements for identifying a UE category (or capacity). Or, whether or not a UE is able to perform a relaying operation can be periodically reported to the eNB (or, upon the aperiodic request of the eNB). In addition, it may consider signaling to a UE designated by the eNB and feedback from the UE. For example, the eNB makes a request for a report on the number of available layers, (the number of) Tx antenna, the number of FFT operations capable of being processed, and the like to candidates to find out the amount of traffic capable of being processed by a corresponding UE and the corresponding UE can report on the topic to the eNB. If the above mentioned information is reported to the eNB in a form of a UE category, since there is no additional feedback, it may be able to reduce feedback overhead. As a different method, if feedback on the abovementioned information is periodically performed (or by the request of the eNB), since the eNB is able to know a current status of a relaying capable UE, it may be able to more precisely select a UE capable of satisfying the requirement of the eNB. The eNB can designate a UE capable of efficiently operating as a relay using the additional feedback information. In case of using the method, it is able to efficiently control the number of relays, resources, and the like.

In the following, an operation between a UE and a UE relay is explained.

A D2D operation can be performed even in a situation that such a scheduler as an eNB does not exist. In order for a UE to forward data to the outside of coverage of the UE, the UE may use a neighboring UE as a relay. To this end, a UE may inform neighboring UEs that the UE is able to operate as a relay or it is necessary for a UE to ask a neighboring UE to perform relaying.

In order for a UE to inform neighboring UEs that the UE is able to perform a relaying operation, the UE may use a physical sidelink broadcast channel (PSBCH) transmitted in a subframe in which a D2D synchronization signal is transmitted. Currently, the PSBCH is configured by DFN (14 bits), a TDD UL-DL configuration (3 bits), In-coverage indicator (1 bit), a sidelink bandwidth (3 bits), and a reserved field (20 bits). A relaying indicator proposed by the present invention can be forwarded using 1 bit of the reserved field or a reserved state of a legacy field. In addition, the UE relays content of PSBCH transmitted from a source, which is determined by the UE as a timing reference in a legacy synchronization operation. In this case, the DFN included in the PSBCH is changed to DFN corresponding to a subframe in which a synchronization signal and PSBCH are transmitted. The in-coverage indicator can also be changed according to a position of the UE. The relaying indicator proposed by the present invention can be changed according to capability of the UE transmitting the PSBCH. For example, when the UE receives the PSBCH irrespective of a value of the relaying indicator, which is received from a synchronization source of the UE, if the UE operates as the synchronization source, the UE can transmit the PSBCH by setting a field of the PSBCH to ‘1’. Having received the PSBCH including the field set to ‘1’, the UE can recognize that a UE capable of performing a relaying operation exists near the UE.

As a different method, it may use physical sidelink discovery channel (PSDCH). According to the present method, a relaying indicator is defined in the PSDCH and the relaying indicator operates in a manner of being identical to the case of the aforementioned PSBCH. By doing so, a reception UE is able to recognize that a UE capable of performing a relaying operation exists near the reception UE. In case of using the PSDCH, since the reception UE is able to specify a relaying UE using a transmission UE ID, and the like included in a discovery signal, it may be able to reduce resource waste (e.g., a plurality of UEs adjacent to each other relay the same data, etc.).

When a UE asks a neighboring UE to perform relaying, it may also be able to use the aforementioned methods of using the PSBCH and the PSDCH. In this case, it may be able to implement the aforementioned operation by defining a relaying request field. As a different method of the relaying request, it may be able to use a sequence index of a synchronization signal. For example, it may be able to newly designate a root index of PSSS for the purpose of the relaying request. Or, it may be able to designate a part of sequence parameters of SSSS for the usage of the relaying request.

Configurations of Devices for Embodiments of the Present Invention

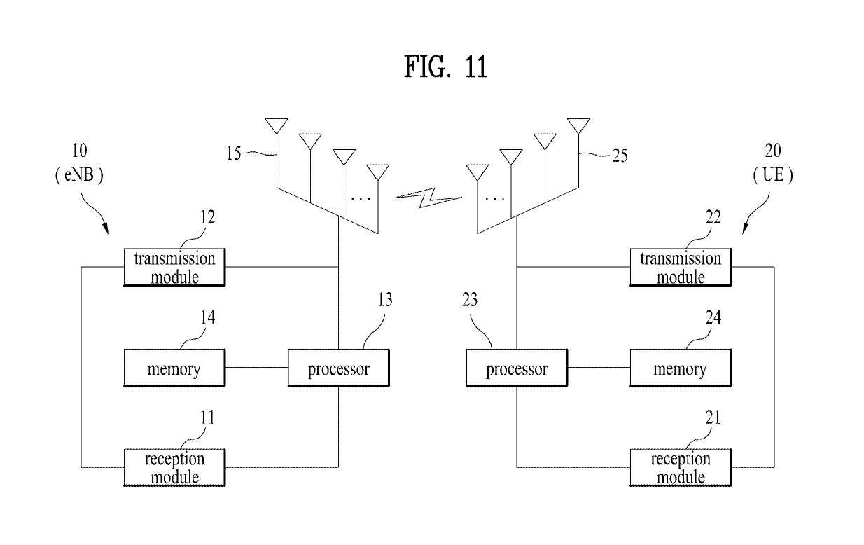

FIG. 11 is a diagram illustrating configuration of a transmit point apparatus and a UE according to one embodiment of the present invention.

Referring to FIG. 11, a transmit point apparatus 10 may include a receive module 11, a transmit module 12, a processor 13, a memory 14, and a plurality of antennas 15. The antennas 15 represent the transmit point apparatus that supports MIMO transmission and reception. The receive module 11 may receive various signals, data and information from a UE on an uplink. The transmit module 12 may transmit various signals, data and information to a UE on a downlink. The processor 13 may control overall operation of the transmit point apparatus 10.

The processor 13 of the transmit point apparatus 10 according to one embodiment of the present invention may perform processes necessary for the embodiments described above.

Additionally, the processor 13 of the transmit point apparatus 10 may function to operationally process information received by the transmit point apparatus 10 or information to be transmitted from the transmit point apparatus 10, and the memory 14, which may be replaced with an element such as a buffer (not shown), may store the processed information for a predetermined time.

Referring to FIG. 11, a UE 20 may include a receive module 21, a transmit module 22, a processor 23, a memory 24, and a plurality of antennas 25. The antennas 25 represent the UE that supports MIMO transmission and reception. The receive module 21 may receive various signals, data and information from an eNB on a downlink. The transmit module 22 may transmit various signals, data and information to an eNB on an uplink. The processor 23 may control overall operation of the UE 20.

The processor 23 of the UE 20 according to one embodiment of the present invention may perform processes necessary for the embodiments described above.

Additionally, the processor 23 of the UE 20 may function to operationally process information received by the UE 20 or information to be transmitted from the UE 20, and the memory 24, which may be replaced with an element such as a buffer (not shown), may store the processed information for a predetermined time.

The configurations of the transmit point apparatus and the UE as described above may be implemented such that the above-described embodiments can be independently applied or two or more thereof can be simultaneously applied, and description of redundant parts is omitted for clarity.

Description of the transmit point apparatus 10 in FIG. 11 may be equally applied to a relay as a downlink transmitter or an uplink receiver, and description of the UE 20 may be equally applied to a relay as a downlink receiver or an uplink transmitter.

The embodiments of the present invention may be implemented through various means, for example, hardware, firmware, software, or a combination thereof.

When implemented as hardware, a method according to embodiments of the present invention may be embodied as one or more application specific integrated circuits (ASICs), one or more digital signal processors (DSPs), one or more digital signal processing devices (DSPDs), one or more programmable logic devices (PLDs), one or more field programmable gate arrays (FPGAs), a processor, a controller, a microcontroller, a microprocessor, etc.

When implemented as firmware or software, a method according to embodiments of the present invention may be embodied as a module, a procedure, or a function that performs the functions or operations described above. Software code may be stored in a memory unit and executed by a processor. The memory unit is located at the interior or exterior of the processor and may transmit and receive data to and from the processor via various known means.

Preferred embodiments of the present invention have been described in detail above to allow those skilled in the art to implement and practice the present invention. Although the preferred embodiments of the present invention have been described above, those skilled in the art will appreciate that various modifications and variations can be made in the present invention without departing from the spirit or scope of the invention. For example, those skilled in the art may use a combination of elements set forth in the above-described embodiments. Thus, the present invention is not intended to be limited to the embodiments described herein, but is intended to accord with the widest scope corresponding to the principles and novel features disclosed herein.

The present invention may be carried out in other specific ways than those set forth herein without departing from the spirit and essential characteristics of the present invention. Therefore, the above embodiments should be construed in all aspects as illustrative and not restrictive. The scope of the invention should be determined by the appended claims and their legal equivalents, and all changes coming within the meaning and equivalency range of the appended claims are intended to be embraced therein. The present invention is not intended to be limited to the embodiments described herein, but is intended to accord with the widest scope consistent with the principles and novel features disclosed herein. In addition, claims that are not explicitly cited in each other in the appended claims may be presented in combination as an embodiment of the present invention or included as a new claim by subsequent amendment after the application is filed.

### INDUSTRIAL APPLICABILITY

The embodiments of the present invention can be applied to various mobile communication systems.

What is claimed is:

1. A method of relaying a signal, which is relayed by a D2D (device-to-device) user equipment (UE) in a wireless communication system, comprising the steps of:
measuring signal strength of a signal received from an eNB; and
if the UE succeeds in decoding the received signal and strength of the received signal is smaller than a predetermined threshold value, relaying a prescribed signal among the signal received from the eNB,
wherein if the UE relays the prescribed signal, although a mode set to the UE corresponds to a mode 2, the UE performs a mode 1 operation.

2. The method of claim 1, wherein the predetermined threshold value is configured for UEs located at a cell edge of the eNB to perform the relaying.

3. The method of claim 2, wherein the predetermined threshold value corresponds to −120 dBm.

4. The method of claim 1, wherein the mode 1 is to directly indicate a resource related to D2D signal transmission by the eNB, wherein the mode 2 is to select a resource related to D2D signal transmission by the UE, and wherein if the UE relays the prescribed signal, a resource used for relaying the prescribed signal is indicated by the eNB.

5. The method of claim 4, wherein the resource used for relaying the prescribed signal is common to all UEs relaying the prescribed signal.

6. The method of claim 1, wherein the prescribed signal corresponds to a downlink signal transmitted in a resource region indicated by the received signal.

7. The method of claim 1, wherein a CRC of the received signal is checked using a relay-RNTI (radio network temporary identifier).

8. A D2D (device-to-device) user equipment (UE) in a wireless communication system, comprising:
a transmitter and a receiver; and
a processor, the processor configured to measure signal strength of a signal received from an eNB, the processor, if the UE succeeds in decoding the received signal and strength of the received signal is smaller than a predetermined threshold value, configured to relay a prescribed signal among the signal received from the eNB
wherein if the UE relays the prescribed signal, although a mode set to the UE corresponds to a mode 2, the UE performs a mode 1 operation.

9. The D2D UE of claim 8, wherein the predetermined threshold value is configured for UEs located at a cell edge of the eNB to perform the relaying.

10. The D2D UE of claim 9, wherein the predetermined threshold value corresponds to −120 dBm.

11. The D2D UE of claim 8, wherein the mode 1 is to directly indicate a resource related to D2D signal transmission by the eNB, wherein the mode 2 is to select a resource related to D2D signal transmission by the UE, and wherein if the UE relays the prescribed signal, a resource used for relaying the prescribed signal is indicated by the eNB.

12. The D2D UE of claim 11, wherein the resource used for relaying the prescribed signal is common to all UEs relaying the prescribed signal.

13. The D2D UE of claim 8, wherein the prescribed signal corresponds to a downlink signal transmitted in a resource region indicated by the received signal.

14. The D2D UE of claim 8, wherein a CRC of the received signal is checked using a relay-RNTI (radio network temporary identifier).
